(19) United States
(12) Patent Application Publication
(10) Pub. No.: US 2011/0292427 A1
(43) Pub. Date: Dec. 1, 2011

(54) IMAGE FORMING APPARATUS AND IMAGE FORMING METHOD

(75) Inventor: Tomokazu Sakabe, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/112,086

(22) Filed: May 20, 2011

Related U.S. Application Data
(60) Provisional application No. 61/347,978, filed on May 25, 2010.

(51) Int. Cl. G06K 15/00

(52) U.S. Cl. 358/1.13

(57) ABSTRACT

According to one embodiment, an image forming apparatus includes an image forming unit configured to form an output image on a medium based on image information, and a control unit configured to calculate a merit value that benefits a user according to a maintenance work of the apparatus carried out by the user.

### CROSS-REFERENCE TO RELATED APPLICATION

This application is based upon and claims the benefit of U.S. Provisional application No. 61/347,978, filed on May 25, 2010; the entire contents of which are incorporated herein by reference.

### FIELD

Embodiments described herein relate generally to an image forming apparatus and an image forming method.

### BACKGROUND

An MFP (multi-function peripheral), which is an image forming apparatus, is a digital multi-function machine for comprehensive use of functions of various office machines including not only scanning, reading and copying images with designated resolution and sheet size, but also an image receiving function via fax, an image receiving function via e-mail, and a print image receiving function via network.

The image forming apparatus uses, for example, replacement components such as photoconductive drums and toners. As printing continues using the image forming apparatus, these replacement components will eventually need replacing. Replacement of these replacement components is maintenance work for the apparatus and therefore should be carried out by the maintenance worker. However, in some cases, the user replaces replacement components that can be easily replaced and poses little risk.

There are also cases where the user performs adjustment work such as image quality adjustment of the image forming apparatus, as well as replacement of components. For example, in some cases, the user carries out color calibration work to adjust image quality of color images.

The purpose of the user's carrying out such replacement and adjustment work is to reduce downtime of the image forming apparatus taken for calling the maintenance worker and carrying out maintenance work. However, from the user's perspective, such work is unfamiliar and troublesome work, which the user wants to avoid as much as possible.

### BRIEF DESCRIPTION OF THE DRAWINGS

FIG. 1 is an exemplary perspective view showing a schematic shape of an MFP according to an embodiment.

FIG. 2 is an exemplary block diagram showing the configuration of copy function of the MFP according to the embodiment.

FIG. 3 is an exemplary block diagram showing the configuration of a control system of the MFP according to the embodiment.

FIG. 4 is an exemplary outer view of an operation panel provided on the MFP according to the embodiment.

FIG. 5 is an exemplary diagram showing discount calculation setting data according to the embodiment.

FIG. 6 is an exemplary diagram showing a count by work file according to the embodiment.

FIG. 7 is an exemplary diagram showing a discrimination flag according to the embodiment. FIG. 8 is an exemplary flowchart showing billing procedures according to the embodiment.

FIG. 9 is an exemplary diagram showing the configuration of a billing count information file according to the embodiment.

FIG. 10 is an exemplary diagram showing the configuration of a discount coefficient table according to the embodiment.

FIG. 11 is an exemplary diagram showing the configuration of a discount calculation table according to the embodiment.

FIG. 12 is an exemplary diagram showing the configuration of an image forming system according to a second embodiment.

### DETAILED DESCRIPTION

In general, according to one embodiment, an image forming apparatus includes an image forming unit configured to form an output image on a medium based on image information; and a control unit configured to calculate a merit value that benefits a user according to a maintenance work of the apparatus carried out by the user.

### First Embodiment

Hereinafter, an MFP 201 will be described as an example of an image forming apparatus according to the embodiment.

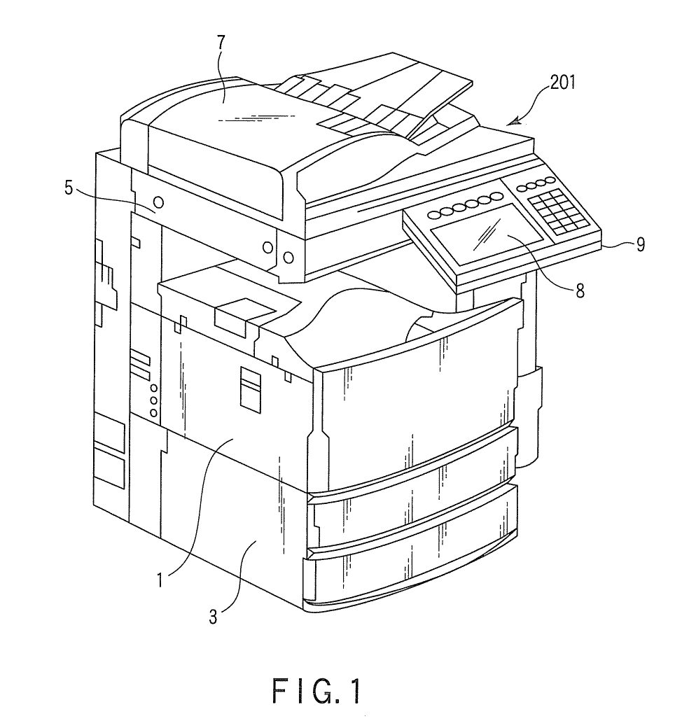

FIG. 1 is an exemplary perspective view showing a schematic shape of the MFP 201 of this embodiment.

The MFP 201 is provided with a printing unit 1, a sheet tray 3, a scanning unit 5, an automatic feeder unit 7, and an operation panel 9.

The printing unit 1 outputs image information, for example, in the form of an output image called hard copy or printout. The sheet tray 3 supplies an output medium that is a sheet of an arbitrary size used for image output to the printing unit 1. The scanning unit 5 takes in image information from a document in the form of image data. The automatic feeder unit 7 sends out the document which is already read to a discharge position from a reading position, and guides the next document to the reading position. The operation panel 9 is an instruction input unit for designating operations of the MFP 201 such as starting image forming by the printing unit 1 or starting reading of image information of a document by the scanning unit 5. The operation panel 9 is provided with an LCD 8 on which to input instructions and display information to the operator.

The MFP 201 can connect to a network or communication channel, not shown, and receive image data via fax or e-mail.

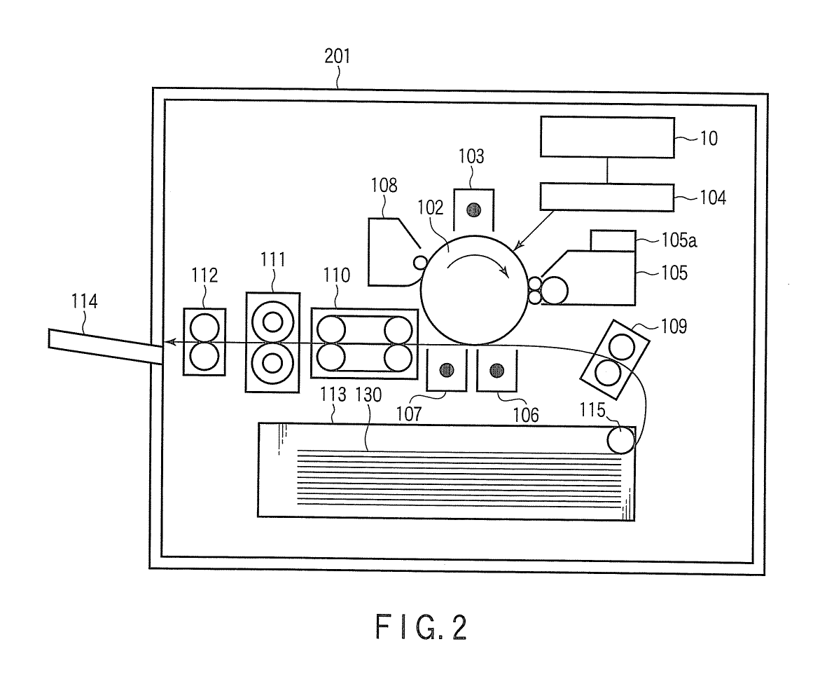

FIG. 2 is an exemplary block diagram showing the configuration of a copy function of the MFP 201 according to the embodiment.

The MFP 201 has a control unit 10, a photoconductive drum 102, a charger 103, a scanning and exposing unit 104, a developing device 105, a transfer charger 106, a separation charger 107, a cleaner 108, a paper supply unit 109, a sheet carrying unit 110, a fixing device 111, a paper discharge unit 112, and a paper discharge tray 114.

The photoconductive drum 102 rotates in a sub scanning direction that is the circumferential direction of the photoconductive drum 102. The charger 103 is arranged near the periphery of the photoconductive drum 102. The charger 103 uniformly charges the surface of the photoconductive drum 102. The scanning and exposing unit 104 emits light and switches light off according to image signals while scanning with a semiconductor laser within the scanning and exposing unit 104. A laser beam emitted from the semiconductor laser is turned by a deflector such as polygon mirror into light scanning in a main scanning direction that is the direction of the rotation axis of the photoconductive drum 102. The laser beam is then cast onto the photoconductive drum 102 by an optical system such as a lens. As the laser beam is cast onto the charged photoconductive drum 102, the potential at the irradiated site drops and an electrostatic latent image is formed.

The developing device 105 applies a developer to the photoconductive drum 102 and thereby forms a toner image on the photoconductive drum 102. The developing device 105 is provided with a toner box 105a in a removable manner. The sheet tray 3 is provided at the bottom of the MEP 201. The paper supply roller 115 separates and sends out sheets 130 in the sheet tray 3 one by one to the paper supply unit 109. The paper supply unit 109 supplies the sheet 130 to a transfer position on the photoconductive drum 102. The transfer charger 106 transfers the toner image to the supplied sheet 130. The separation charger 107 separates the sheet 130 from the photoconductive drum 102.

The sheet 130 with the toner image transferred thereto is carried by the sheet carrying unit 110. The fixing device 111 fixes the toner image to the sheet 130. The paper discharge unit 112 discharges the sheet 130 with the image printed thereon to the paper discharge tray 114.

After transfer of the toner image to the sheet 130 is finished, the residual toner on the photoconductive drum 102 is removed by the cleaner 108. The photoconductive drum 102 restores its initial state and becomes on standby for the next image forming.

As the above process is repeated, image forming is continuously carried out.

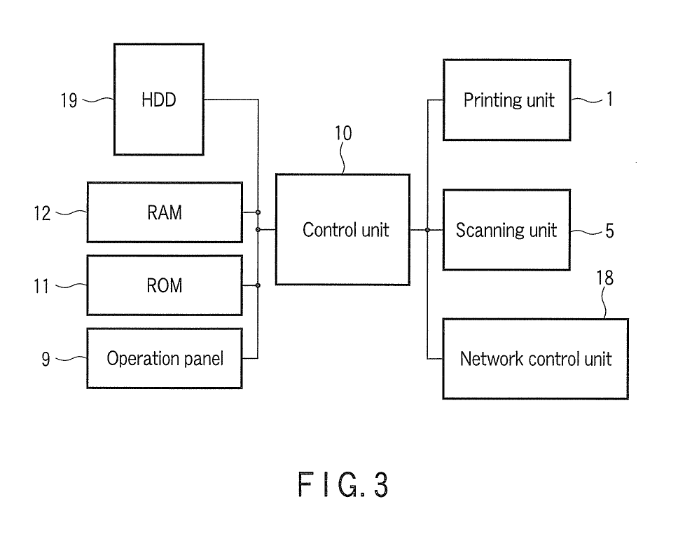

FIG. 3 is an exemplary block diagram showing the configuration of a control system of the MFP 201 according to the embodiment.

The MFP 201 also has a control unit 10, a ROM 11, a RAM 12, a network control unit 18 and an internal storage unit (HDD) 19, as well as the printing unit 1, the sheet tray 3, the scanning unit 5, the LCD 8 and the operation panel 9. These units are connected via a system bus.

The control unit 10 controls each of the above hardware units connected via the system bus. In the ROM 11, various control programs necessary for operation of the MFP 201 are stored. The RAM 12 is a buffer memory in which data generated at the time of executing control programs are temporarily stored.

The network control unit 18 is an interface for transmitting and receiving information via a network such as the Internet. The HDD 19 is a non-volatile storage medium installed inside the MFP 201. History information about component replacement is recorded in the HDD 19.

The control unit 10 has a billing count calculating unit 10a, a discount calculation determining unit 10b, a discount information acquiring unit 10c, a discount coefficient acquiring unit 10d and a discount calculating unit 10e, for executing billing. The functions of each unit to execute billing will be described later.

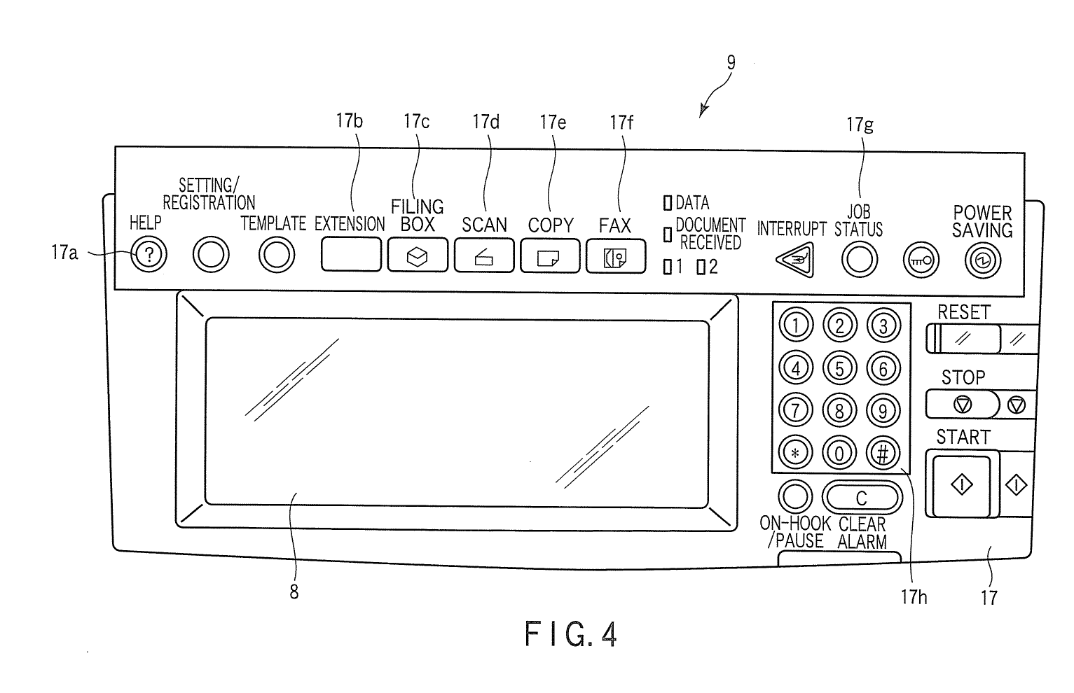

FIG. 4 is an exemplary outer view of the operation panel 9 provided on the MFP 201 according to the embodiment. The user carries out setting and confirmation of the MFP 201 via this operation panel 9. The operation panel 9 is provided with a display unit 8 and an operation unit 17. The display unit 8 includes a touch panel and the state of the MFP 201, operation procedures, and various instructions to the user or the like are displayed thereon. The operation unit 17 is provided with various operation buttons for operating the MFP 201.

As keys to call screens on which to select and set functions, a help button 17a, a function extension button 17b, a filing box button 17c, a scan button 17d, a copy button 17e, a fax button 17f and a status confirmation button 17g and the like are arranged. In addition, numeric keys 17h or the like for entering set values and for confirming information are also arranged.

Of these operation buttons, functions of main buttons will be described. The help button 17a is used to inquire what operation should be carried out next, and so on. The extension button 17b is operated to use an extension function. The filing box button 17c is used to take out saved image data. The scan button 17d is used to use the scanning function. The copy button 17e is used to use the copy function. The fax button 17f is used to use the fax function. The status confirmation button 17g is used to execute private printing. The ten keys 17h are used to enter numbers.

Next, merit giveback processing of the embodiment will be described.

In merit giveback processing according to the embodiment, when the user carries out a work which reduces burden on the maintenance worker, a merit is given back to the user according to the work. In the first embodiment, a merit to be given back may be reducing the amount of billing the user.

The user closes a contract with the service center in charge of maintenance of the MFP 201. This contract prescribes that when the user carries out a work which reduces burden on the maintenance worker, the amount of billing the user is reduced according to the work. The contract prescribes target work contents and reduction values.

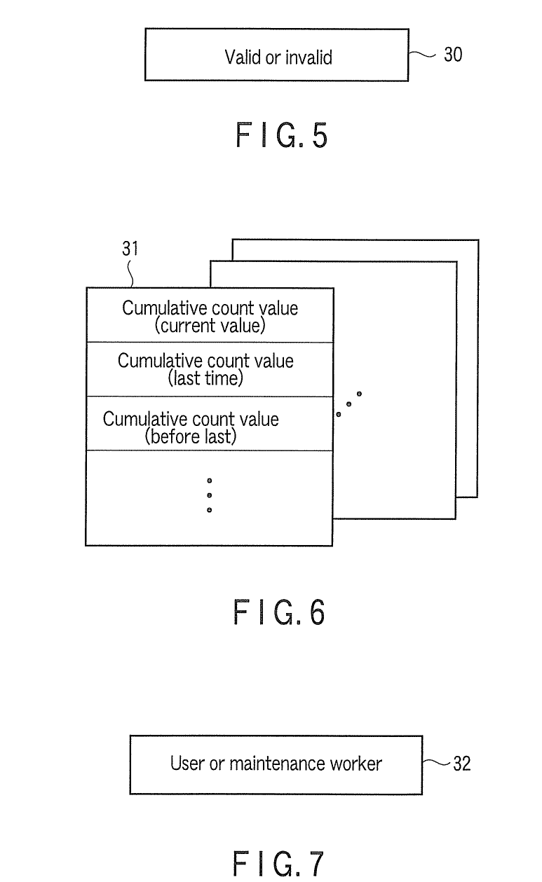

The maintenance worker enters setting of valid discount from the operation panel 9 before the MFP 201 is delivered where the contract is closed before the delivery of the MFP 201, and after the MFP 201 is delivered where the contract is closed after the delivery of the MFP 201. Meanwhile, when the contract is not closed, the maintenance worker enters setting of invalid discount from the operation panel 9. Information of this setting entry is saved in the HDD 19 as discount calculation setting data 30. FIG. 5 is an exemplary diagram showing the discount calculation setting data 30 according to the embodiment.

The MFP 201 is also provided with a count by work file 31 for each work as reduction target. FIG. 6 is an exemplary diagram showing the count by work file 31 according to the embodiment. In the count by work file 31, the cumulative count value (current value) for the work in question, the cumulative count value (last time) at the time of last billing, the cumulative count value (before last) at the time of the billing before last, and the like are provided. With this file configuration, the count value as a target of billing reduction can be found by the cumulative count value (current value) minus the cumulative count value (last time). In the count by work file 31, the cumulative count value of n times before is saved. However, the file may be configured to save the current value and last value.

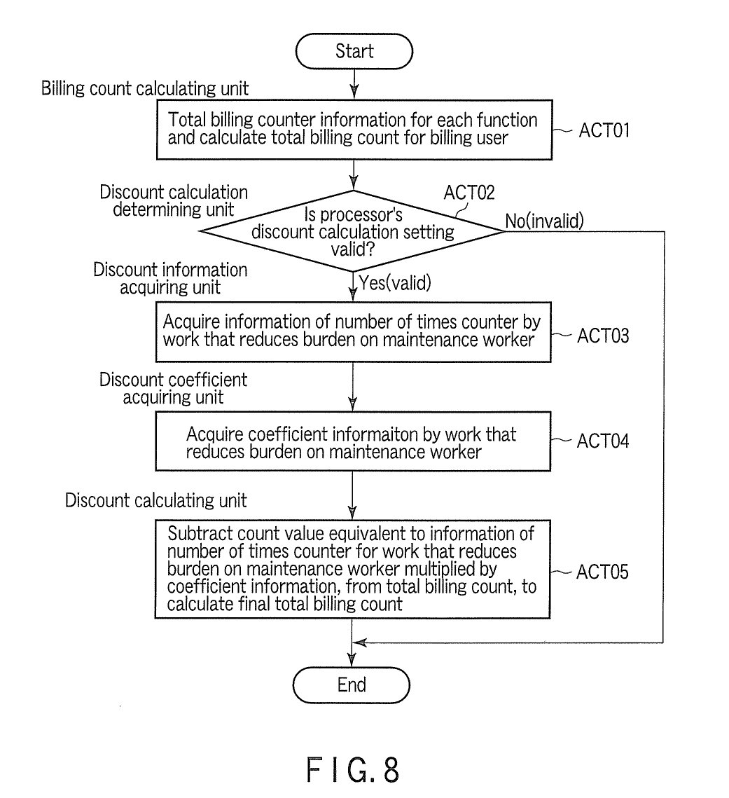

FIG. 7 is an exemplary diagram showing a discrimination flag 32 according to the embodiment. As described above, a target work is a work that should originally be carried out by the maintenance worker.

Therefore, whether the work is carried out by the user or the maintenance worker needs to be discriminated. Thus, the discrimination flag 32 is usually set to assume that the user carries out the work, and when the maintenance worker carries out the work, the maintenance worker enters, from the operation panel 9, information that the subsequent work is the maintenance worker's work. Then, when this work is finished by the maintenance worker, the maintenance worker enters, from the operation panel 9, information that the subsequent work is the user's work.

Thus, when the discrimination flag 32 is set to indicate the user's work, the number of times the work is carried out (count value) is automatically added to the cumulative count value (current value) in the count by work file 31.

FIG. 8 is an exemplary flowchart showing billing procedures according to the embodiment.

For example, when billing the user for the monthly use fee of the MFP 201, the maintenance worker or salesperson enters an instruction to calculate the total billing count from the operation panel 9. In ACT 01, the billing count calculating unit 10a of the control unit 10 totals billing counter information for each function and calculates the total billing count to bill the user.

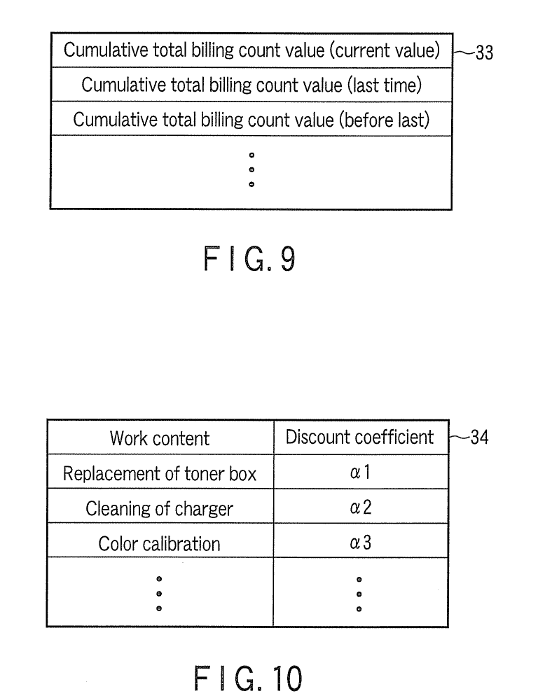

FIG. 9 is an exemplary diagram showing the configuration of a billing count information file 33 according to the embodiment.

In the billing count information file 33, the cumulative total billing count value (current value), the cumulative total billing count value (last time) at the time of last billing, the cumulative total billing count value (before last) at the time of the billing before last, and the like are provided. With this file configuration, the total billing count value as a target of billing can be found by the cumulative total billing count value (current value) minus the cumulative total billing count value (last time). In the billing count information file 33, the cumulative total billing count value of n times before is saved. However, the file may be configured to save the current value and last value.

In ACT 02, the discount calculation determining unit 10b of the control unit 10 determines whether discount calculation setting is valid or not. That is, the discount calculation determining unit 10b examines the discount calculating setting data 30 and examines which of valid discount and invalid discount is set.

When invalid discount is set (ACT 02, No), the control unit 10 regards the total billing count value found in ACT 01 as the final total billing count to bill the user.

When valid discount is set (ACT 02, Yes), the discount information acquiring unit 10c of the control unit 10 finds, in ACT 03, the count value by work which reduces burden on the maintenance worker. That is, the discount information acquiring unit 10c finds the count value to be a target of billing reduction for each work with reference to the count by work file 31.

In ACT 04, the discount coefficient acquiring unit 10d of the control unit 10 acquires coefficient information by work that reduces burden on the maintenance worker. FIG. 10 is an exemplary diagram showing the configuration of a discount coefficient table 34 according to the embodiment. Discount coefficients for each work content are stored in the discount coefficient table 34. For example, when the toner box 105a is replaced, the discount coefficient is α1. When the charger 103 is cleaned, the discount coefficient is α2. When color calibration is carried out, the discount coefficient is α3.

In ACT 05, the discount calculating unit 10e of the control unit 10 subtracts a counter value equivalent to the count value of the number of times of the work that reduces burden on the maintenance worker multiplied by the coefficient information, from the total billing count value, and thus calculates the final total billing count value.

The final total billing count value (LTC) is expressed by the following equation, where TC is the total billing count value, Ji is the count value of the number of times of the work (i), and αi is the discount coefficient of the work (i):

LTC=TC−Σ(Ji)×(αi)

The maintenance worker or salesperson acquires the final total billing count value. The final total billing count value is data to calculate the amount of billing the user. The billing amount is calculated at the service center.

After calculating the final total billing count value, the control unit 10 shifts to the past data by one in the count by work file 31 and the billing count information file 33 and carries out preparation for new billing.

Processing to calculate the final total billing count will be described with reference to the flowchart of FIG. 8 using specific numeric values. It is assumed that discount calculation setting is valid and replacement of the toner box 105a and cleaning of the charger 103 are targets of discount. It is also assumed that the total billing count is 100, the count by the counter of the number of times the toner box 105a is replaced is 3, the count by the counter of the number of times the charger 103 is cleaned is 1, the toner box 105a replacement discount coefficient is 2.0, and the charger 103 cleaning discount coefficient is 3.0. Under such conditions, the final total billing count is calculated.

In ACT 01, the billing count calculating unit 10a calculates the total billing count based on billing counter information for each function. In this example, the total billing count is calculated as 100.

In ACT 02, the discount calculation determining unit 10b determines whether discount calculation is valid or not. In this example, discount calculation is set as valid and therefore the result is Yes (valid).

In ACT 03, the discount information acquiring unit 10c acquires the count value by work which reduces burden on the maintenance worker. In this example, the count of 3 by the counter of the number of times of toner box replacement and the count of 1 by the counter of the number of times of charger cleaning are acquired. In ACT 04, the discount coefficient acquiring unit 10d acquires coefficient information by work which reduces burden on the maintenance worker. In this example, the toner box replacement discount coefficient 2.0 and the charger cleaning discount coefficient 3.0 are acquired.

In ACT 05, the discount calculating unit 10e calculates the final total billing count. In this example, 100−3×2.0−1×3.0=91 results, meaning that the final total billing count is 91.

### Variation of First Embodiment

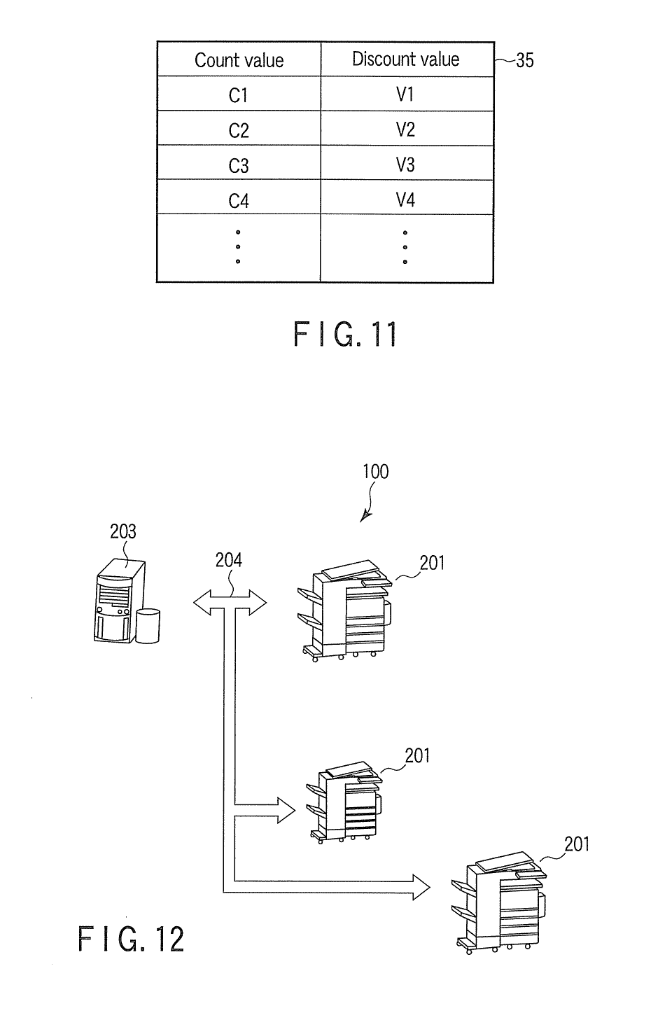

While the discount coefficient α is used in the first embodiment, a discount count value may be directly found from count values by work. FIG. 11 is an exemplary diagram showing the configuration of a discount calculation table 35 according to the embodiment. In the discount calculation table 35, discount values are stored for each count value. According to the discount calculation table 35, the discount value is V1 when 0<count value≦C1 holds. The discount value is V2 when C1<count value≦C2 holds. The discount value is V3 when 02 count value≦C3 holds, and so forth.

The discount value V shown in FIG. 11 may also be the discount count value described in the first embodiment. The discount value V may also be the discount amount. When the discount value V is the discount amount, the amount of billing the user is calculated based on the total billing count found in ACT 01 of FIG. 8 and the discount value V.

### Second Embodiment

In a second embodiment, as a way of giving back the merit to the user when the user carries out a work that reduces burden on the maintenance worker, the limited number of sheets allocated to the user is increased. The same parts as in the first embodiment are denoted by the same reference numerals and will not be described further in detail.

FIG. 12 is an exemplary diagram showing the configuration of an image forming system according to the second embodiment. An image forming system 100 has at least one MFP 201 and a server 203, which are connected via a network 204.

In the image forming system 100, the number of times of each operation of the MFP 201 is limited in advance. The server 203 performs control so that none of the connected MFPs 201 will operate more than the limited number of times.

For example, the server 203 can limit the number of sheets printed not to exceed a reference value irrespective of type. The server 203 can limit the number of sheets printed in color print and the number of sheets printed in monochrome print so that these numbers will not exceed respective reference values.

The server 203 can limit the numbers of sheets printed for each print job such as copy, network print, and USB print so that these numbers will not exceed respective reference values. The server 203 can limit the numbers of sheets printed for each size of sheet such as “A4” and “B5” so that these numbers will not exceed respective reference values. The serve 103 can limit the number of sheets printed according to the types of sheet such as “normal paper” and “OHP” so that these numbers will not exceed respective reference values.

The MFP 201 transmits the type and the number of times of the work executed by the user to reduce the burden on the maintenance worker, to the server 203 in predetermined timing or arbitrary timing. The server 203 increases the limited number of times to the MFP 201 based on the type and the number of times of the work and thus designates a new limited number of times.

For example, when the number of printable sheets in a certain MFP 201 up to now is 1000, carrying out a work at the MFP 201 that reduces burden on the maintenance worker causes the server 203 to designate a new number of printable sheets of 1100. That is, the MFP 201 can acquire the increased number sheets printed as a merit.

The information transmitted by the MFP 201 to the server 203 is not limited to the type and the number of times of the work. The information also includes information acquired by calculations using coefficients and tables, such as the number of times correction is made using a discount coefficient or a value corresponding to the discount value V, as described in the embodiments. The MFP 201 itself can calculate the increase in the number of sheets printed, as in the embodiments.

According to the above embodiments, when the user carries out a work that reduces burden on the maintenance worker, a merit corresponding to the work is given back to the user. The user is incentivized to carry out the work that reduces burden on the maintenance worker, active execution of the work by the user is anticipated. Consequently, reduction in image quality deterioration in the MFP 201, reduction in downtime and the like enable improvement in reliability of the MFP 201.

In the embodiments, the discount coefficient (α) used to find the final total billing count value (LTC) calculated by the control unit 10 can be understood as weighting the number of times count value.

The counter value, the discount value V and the increase in the number of sheets printed, calculated by the number of times count value of the work that reduces burden on the maintenance worker multiplied by the coefficient information, can be understood as merit values that benefit the user.

Each function described in the embodiments may be configured with hardware or may be realized by a computer reading a program describing each function with software. Each function may also be configured by selecting either software or hardware as needed.

Each function can also be realized by a computer reading the program stored in a recording medium, not shown. Here, the recording medium in this embodiment may have any recording format as long as the recording medium is a computer-readable recording medium in which the program can be recorded.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit configured to form an output image on a medium based on image information; and
a control unit configured to calculate a merit value that benefits a user according to a maintenance work of the apparatus carried out by the user.

2. The apparatus of claim 1, wherein the control unit totals values acquired by weighting the number of times of each maintenance work carried out by the user to calculate the merit value.

3. The apparatus of claim 2, wherein the maintenance work includes at least one of component replacement and image quality adjustment in the apparatus.

4. The apparatus of claim 3, wherein the maintenance work includes at least one of toner box replacement, charger cleaning, and color calibration.

5. The apparatus of claim 3, wherein the merit value is a value subtracted from a total billing count value for billing the user.

6. The apparatus of claim 3, wherein the merit value is a value to increase the number of times the apparatus can operate.

7. The apparatus of claim 3, wherein a data item indicating whether calculation of the merit value is valid or invalid is provided,
when the item indicates that the calculation is valid, the control unit executes the calculation of the merit value, and
when the data item indicates that the calculation is invalid, the control unit does not execute the calculation of the merit value.

8. The apparatus of claim 1, wherein the control unit finds a value corresponding to the number of times of each maintenance work carried out by the user, then totals the value and calculates the merit value.

9. The apparatus of claim 8, wherein the maintenance work includes at least one of component replacement and image quality adjustment in the apparatus.

10. The apparatus of claim 9, wherein the maintenance work includes at least one of toner box replacement, charger cleaning, and color calibration.

11. The apparatus of claim 9, wherein the merit value is a value subtracted from a total billing count value for billing the user.

12. The apparatus of claim 9, wherein the merit value is a value to increase the number of times the apparatus can operate.

13. The apparatus of claim 9, wherein a data item indicating whether calculation of the merit value is valid or invalid is provided,
when the item indicates that the calculation is valid, the control unit executes the calculation of the merit value, and
when the data item indicates that the calculation is invalid, the control unit does not execute the calculation of the merit value.

14. An image forming method for an image forming apparatus comprising an image forming unit configured to form an output image to a medium based on image information, the method comprising:
calculating a merit value that benefits a user according to a maintenance work of the apparatus carried out by the user.

15. The method of claim 14, wherein in the calculation of the merit value, values acquired by weighting the number of times of each maintenance work carried out by the user are totaled to calculate the merit value.

16. The method of claim 15, wherein the maintenance work includes at least one of component replacement and image quality adjustment in the apparatus.

17. The method of claim 16, wherein the merit value is a value subtracted from a total billing count value for billing the user.

18. The method of claim 15, wherein in the calculation of the merit value, a value corresponding to the number of times of each maintenance work carried out by the user and the corresponding value is totaled to calculate the merit value.

19. The method of claim 18, wherein the merit value is a value subtracted from a total billing count value for billing the user.

20. An image forming apparatus comprising:
means for forming an output image on a medium based on image information; and
means for calculating a merit value that benefits a user according to a maintenance work of the apparatus carried out by the user.
